(19) United States
(12) Patent Application Publication
(10) Pub. No.: US 2008/0273774 A1
(43) Pub. Date: Nov. 6, 2008

(54) SYSTEM AND METHODS FOR CAPTURING A MEDICAL DRAWING OR SKETCH FOR GENERATING PROGRESS NOTES, DIAGNOSIS AND BILLING CODES

(76) Inventors: Maged Mikhail, Darien, IL (US); J. Gordon Wright, Downers Grove, IL (US)

Correspondence Address: MCGUIREWOODS, LLP, 1750 TYSONS BLVD, SUITE 1800, MCLEAN, VA, 22102, US

(21) Appl. No.: 12/100,865

(22) Filed: Apr. 10, 2008

Related U.S. Application Data
(60) Provisional application No. 60/924,248, filed on May 4, 2007.

(51) Int. Cl. G06K 9/00

(52) U.S. Cl. 382/128

(57) ABSTRACT

A system and methods are provided that allows an end user such as a doctor to draw a picture representation of a patient physical findings such as symptoms, treatments, imaging results or other procedures so that the rendering is captured and translated to a textual description as progress notes, diagnosis, or for inclusion with an electronic medical record, for example. The captured rendering (“sketch-to-text”) is storable and recallable for future annotations as needed. The translated description may be used for automated billing.

### CROSS-REFERENCE TO RELATED APPLICATIONS

This non-provisional patent application claims benefit and priority to U.S. Provisional patent application No. 60/924,248, filed May 4, 2007, entitled SYSTEM AND METHODS FOR CAPTURING A MEDICAL DRAWING OR SKETCH FOR GENERATING PROGRESS NOTES, DIAGNOSIS AND BILLING CODES, the disclosure of which is incorporated by reference herein in its entirety.

### BACKGROUND OF THE INVENTION

1. Field of the Invention

The invention is generally related to system and methods for capturing a medical drawing and, more particularly, to a system and methods for capturing medical drawings or sketches for generating progress notes, diagnosis and/or billing codes.

2. Related Art

Medical records typically comprise “notes” describing the observations that physicians have made as a result of a history, a physical exam, or a procedure. Sometimes, the notes are supplemented with the aid of a “drawing” or a “sketch.” The notes might be handwritten, or they might be transcriptions of the physician's dictated notes, or they might be “reports” which are generated by an Electronic Medical Record (EMR) system using a system of templates and data fields. These medical records are then used for patient care, education, research, and to comply with legal, insurance, and regulatory requirements. In addition to creating a medical record, the physician typically needs to “code” the clinical encounter so the physician's efforts can be remunerated. In the United States, this typically involves the use of so-called ICD (International Classification of Diseases) codes and CPT (Current Procedural Terminology) codes. In other healthcare systems in other countries, similar codes are used to classify and summarize the diagnosis and the clinical encounter.

Two pertinent problems with handwritten notes are that they are (1) time consuming, and (2) often difficult to read, among other problems. Furthermore, they are not as standardized as multiple choice data fields, and because they are more like “analog signals” than “digital data,” they cannot be scrutinized, analyzed, or categorized as is the case with digital data. To address these problems, many EMRs have been developed in the last few decades, and have enjoyed some success in solving the two problems described earlier in this paragraph.

However, the problems with the prior art is that the “drawing” or “sketched’ part of the medical record has had very little attention and even less support from EMR systems. This is unfortunate and represents a major opportunity for improvement because, as common sense tells us, “one picture is worth a thousand words.” In the realm of medical records, a “drawing” or a “sketch” in a medical record creates a tremendous savings of time and increased accuracy of reporting, yet many EMRs have only rudimentary support for this important part of creating a medical record and documenting the clinical encounter.

For example, some EMRs have included software features that allow the physician to make supplemental free-hand drawings of the physical findings, imaging results, or procedures performed, yet these prior art EMRs have typically used bitmap images for their drawings, and have no significant linkage to the data elements in the EMR. These bitmaps have a limited capacity to document the encounter because the dataset which comprises the image is nothing more than “colored bits.” These colored bits allow the end-user to view and visually interpret the image properly, but the dataset from which the image is mostly derived is difficult to analyze because the colored bits contain no “Medical” data representation. As such, bitmaps are no different than digital photographs, which are difficult to analyze with a software program. This difficulty comes from the fact that a photograph has no constraints on it, and could be a photograph of nearly anything. The same is true of a bitmap.

Some recently developed EMRs have gone a step further by using standardized pictographs which are symbols representing a concept, object, activity, place or event by means of an illustration that do not allow or require any real free-hand drawing. Some EMRs have even gone so far as to “link” the pre-defined pictographs with pre-defined data text fields such that when a physician selects a pictograph to supplement the medical record, a string of text is added to the written part of the medical record's generated report. For example, a physician might choose a pictograph illustrating that there is a tumor that can be felt in the upper-outer quadrant of the patient's right breast, and both the pictograph and the corresponding text (“ . . . there is a palpable tumor in the upper-outer quadrant of the right breast”) would appear in a report generated by the EMR.

Exemplary problems in the prior art:
1) None of these prior art EMRs has the software features that records free-hand drawings of the physical findings, imaging results and/or procedures performed and convert the drawings into:
   a) A descriptive text phrase, or
   b) A data element like a Current Procedural Terminology (CPT) code or a Medical Diagnosis (ICD-9) diagnosis.
2) Furthermore, none of the prior art EMRs has software features that display drawings in a standardized manner that allows the end-user to view the progress of the patient over time, as represented by changes in the sketches or drawings.

### SUMMARY OF THE INVENTION

The invention satisfies the foregoing needs and avoids the drawbacks and limitations of the prior art by providing an apparatus, system and methods for solving and overcoming the limitations of the prior art, resulting in tremendously increased speed and accuracy in creating a medical record, and “coding” the encounter with the proper CPT and ICD codes for billing and other purposes.

In one aspect, a system for capturing medical information is provided. The system includes a first software component that receives pictorial input that represents at least one of a physical finding and a treatment associated with an anatomical portion of a patient, a second software component that translates the pictorial input into Cartesian coordinates representative of the received pictorial input, a third software component that records the translated pictorial input as a dataset for storing, wherein the dataset is recallable for annotation or updating, a display software component that is configured to display the anatomical portion of the patient using the dataset to facilitate recording a diagnosis or a treatment associated with the patient, wherein all of the software components execute on a computer platform.

In another aspect of the invention, a method for capturing medical information is provided. The method includes outputting an electronic rendering of a body part based on a selection for receiving a pictorial annotation representative of a medical condition or treatment of at least a portion of the body part, receiving the pictorial annotation, translating the pictorial annotation into storable indicia representative of the pictorial annotation so that the indicia are recallable for updating with additional annotation, and associating at least one of the pictorial annotation and the storable indicia with a electronic medical record (EMR) viewable as part of the EMR.

In another aspect, a method of documenting medical findings is provided. The method includes receiving free-hand input to annotate a computer generated visual representation of a body part, translating the free-hand input to a dataset representative of multiple characteristics of the body part, associating the information contained in the dataset with an electronic medical record (EMR).

In yet another aspect, a method of documenting medical findings is provided. The method including receiving a tool selection to select a tool for annotating a computer generated visual representation of a body part, receiving free-hand input to annotate the computer generated visual representation of a body part, translating the free-hand input to a dataset representative of multiple characteristics of the body part, the dataset including information related to the tool selected for annotating the computer generated visual representation of a body part, and recalling the dataset and using the stored information related to the tool for recreating the annotated computer generated visual representation of the body for display or updating.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention, are incorporated in and constitute a part of this specification, illustrate embodiments of the invention, and together with the detailed description, serve to explain the principles of the invention. No attempt is made to show structural details of the invention in more detail than may be necessary for a fundamental understanding of the invention and the various ways in which it may be practiced. In the drawings:

FIG. 1 is an illustration of an embodiment showing a user interface including a basic drawing area and related toolbox, constructed according to principles of the invention;

FIG. 2 is an illustration of an embodiment of the diagnosis tools as part of a tool box, constructed according to principles of the invention;

FIG. 3 is an illustration of an embodiment of ultrasound tools selection options, selectable for use by a user, constructed according to principles of the invention;

FIG. 4 is an illustration of an embodiment of Encovenous Obliteration (EVO) marking tools selection options, selectable for use by a user, constructed according to principles of the invention;

FIG. 5 is an illustration of an embodiment of treatment tools selection options, selectable for use by a user, constructed according to principles of the invention;

FIG. 6 is an illustration of an embodiment of other tool options, selectable for use by a user, constructed according to principles of the invention;

FIG. 7 is an illustration of an encounter list, according to principles of the invention;

FIGS. 8A and 8B are an illustrations of an embodiment showing region definition/editing tools, constructed according to principles of the inventions;

FIGS. 9A and 9B are illustrations of an embodiment showing pictorially a process of converting coordinates to region names as part of the text generation process, according to principles of the invention;

FIG. 10 is a flow diagram of an embodiment showing steps of using MediDraw, according to principles of the invention;

FIG. 11 is a flow diagram of an embodiment showing steps of the invention;

FIG. 12 is a flow diagram of an embodiment showing steps of using the invention; and

FIG. 13 is a flow diagram of an embodiment showing steps of using the invention.

### DETAILED DESCRIPTION OF THE INVENTION

The embodiments of the invention and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the invention. The examples used herein are intended merely to facilitate an understanding of ways in which the invention may be practiced and to further enable those of skill in the art to practice the embodiments of the invention. Accordingly, the examples and embodiments herein should not be construed as limiting the scope of the invention, which is defined solely by the appended claims and applicable law. Moreover, it is noted that like reference numerals represent similar parts throughout the several views of the drawings.

It is understood that the invention is not limited to the particular methodology, protocols, devices, apparatus, materials, applications, etc., described herein, as these may vary. It is also to be understood that the terminology used herein is used for the purpose of describing particular embodiments only, and is not intended to limit the scope of the invention. It must be noted that as used herein and in the appended claims, the singular forms “a,” “an,” and “the” include plural reference unless the context clearly dictates otherwise.

Unless defined otherwise, all technical and scientific terms used herein have the same meanings as commonly understood by one of ordinary skill in the art to which this invention belongs. Preferred methods, devices, and materials are described, although any methods and materials similar or equivalent to those described herein can be used in the practice or testing of the invention. Names herein of functions, programs, software routines, and the like, are merely exemplary for explanation purposes, and other appropriate naming conventions may be used. In one aspect, the system and methods of the invention is generally directed to an enhanced electronic medical records (EMR) program, known herein as MediDraw, which includes a drawing program that allows the clinician to draw a picture representation of the physical findings and the treatments that are performed. These drawings may be done on a tablet computer, or similar computer, which typically has a graphical representation of a white piece of paper with a stylized, “pen-and-line” drawing. These drawings are done in multiple layers using tools that are specific to the type of practice. The bottom layer, called the “background layer,” is typically constant and does not vary from patient to patient. Each visit is typically documented on a separate area so that it is possible to show the progress of the patient from visit to visit.

The “lines” that a clinician might draw on the computer screen are translated into a set of Cartesian coordinates, and a numeric code number that indicates the color of the line, the width of the line, its transparency, and other graphical characteristics. This defined dataset may be stored in an electronic computer file in ASCII format, for example, so it can be recalled and so that it can “re-draw” the drawing, as needed for future use.

In certain aspects, the system and methods of the invention operates so that the drawing itself updates database fields and not the other way around, with intelligent analysis of the associated coordinates together with the provided tools and tool options being central aspects of the MediDraw program.

In the case of vein practice application, the tools may include any of:
Spider veins marking tool,
Varicose veins marking tool,
Laser treatment tool, and
Sclerotherapy treatment tool.

The layers may include:
Surface layers; e.g., exam observations as well as surface treatments, and
Deep layer; e.g., results of diagnostic ultrasound studies performed during an encounter.

The background layer may include, as described more below:
Two human legs (right and left), and
Four views (right side, left side, front and back).

The EMR system and methods of the invention analyzes the dataset and produces a text description of the drawing. The result of this conversion of the dataset to text typically produces one or more medical records which documents the physical findings, the treatment interventions, and/or the diagnostic imaging, which also results in
A graphical drawn representation,
A standard text description format, and
The appropriate CPT and ICD-9 Codes that would be required for billing such encounters, which could be produced in a way that would interface with most medical billing software.

### MediDraw Applications

There are typically five basic checks or observations that a clinician performs during a physical exam: inspection, palpation, percussion, auscultation, and smell. In some subspecialties, almost all of the physical exam may be done with inspection alone. These types of subspecialties lend themselves to a graphical drawing to represent the physical exam. Examples of such subspecialties include vein care, ophthalmology, dermatology, wound care, orthopedics, podiatry, and cosmetic plastic surgery. In addition, certain types of imaging sub-specialty work like nuclear medicine, obstetric ultrasound, and mammography may also benefit from the systems and methods of the invention, if the line-and-pen background drawing were replaced by appropriate standardized image-views from their respective imaging machines.

The more sub-specialized the application, the more limited the number of diagnoses. For this reason, the system may have somewhat limited functionality for internal medicine, emergency room medicine, general surgery, or general pediatrics. Examples of subspecialties that use a limited number of diagnoses include vein care, ophthalmology, cosmetic plastic surgery, podiatry, and chiropractic medicine and others. More generalized areas of medicine have a broader range of therapeutic options and may have limited application.

Exemplary MediDraw benefits include:

Providing excellent documentation,
Easy visual documentation,
Ease of comparison between patient encounters to document progress,
Pictures are more direct and to the point than verbal communications,
Pictures cross culture boundaries,

Enhancing patient care and charge capture at the same time, and

Time and cost savings for most clinicians.

### MediDraw Technical Environment

An exemplary MediDraw Technical environment may be deployed using, for example:

Microsoft Windows XP SP2, and

Microsoft Visual Basic Version 6.0 SP5.

In addition, the following exemplary tools may be required for fuller operation of the system but may be replaced by similar functional products:

Microsoft Access 2003, or later, and

Lytec 2005, or later.

### Drawings in General

MediDraw provides a electronic medical records (EMR) program (either as a complete EMR system or as a component of a complete EMR system) that permits an end user to draw (e.g., free-hand) a picture representation of the physical findings, imaging results and/or any procedures that were performed, or even some of the patient's symptoms and produces a text description of the drawing, then populate the associated database fields with data that correspond to the physical findings, imaging results, and/or any procedures that were drawn using the MediDraw drawing program. These drawings may be done on a tablet computer which typically includes a graphical representation of a white piece of paper with a stylized, “pen-and-line” drawing on it. The stylized, pen-and-line drawing is referred to as “the background” because it is usually constant and does not vary from patient to patient. The background drawing is meant to graphically represent the general anatomic area under consideration, which may be nearly any part of a patient's body. The drawings are done using “tools” that are tailored specific to the practice. For example, in a phlebology (vein care) practice, a commonly used tool draws a bluish colored line representing a “varicose vein measuring 2-6 mm in diameter;” Whereas, the same tool may not be useful in an ophthalmology practice, where a line of a similar size and color might be used to represent a “retinal detachment”.

In some embodiments of this invention, drawings may be made to represent different “layers” of the same anatomic region (for example, superficial or deep). In the “phlebology” embodiments of this invention, a “deep” layer is used to represent the results of ultrasound imaging tests that produce imaging results from veins under the surface of the skin.

The intelligent analysis of the lines that are drawn by the clinician may be made possible in part because the drawing region may be constrained by the anatomic region under consideration. The “background” drawing may be reduced to a series of horizontal lines that define geometric subsets of the entire anatomic region represented in the “background” drawing. The MediDraw program analyzes the “lines” drawn by the clinician to see if they are (or are not) in a particular region. The analysis allows the MediDraw program to describe by annotation the anatomic region where the drawing tool has indicated a particular type of pathology, the resolution of pathology, or other physical findings, imaging results, or procedure(s) performed.

The “lines” that the clinician draws on the computer screen may be translated typically into a set of Cartesian coordinates, plus a numeric code number that indicates the graphical characteristics of the “tool” (e.g., the color of the line, the width of the line, its transparency, and other graphical characteristics). This defined dataset may be stored in an electronic computer file in an ASCII format (or similar format) so it may be recalled, and so the drawing may be “re-drawn,” updated or annotated, if needed. So, in one aspect, the drawing itself updates database fields, and not the other way around. The intelligent analysis of the Cartesian coordinates together with the tools and tool options provides significant advantages over the prior art.

During use, the invention may also convert the dataset saved from the drawings into text strings that may be used in the generation of reports, or discrete data fields that may be used for the submission of billing claims, or for the accounting of clinician activity in the case of socialized medicine systems. These are a few of the examples of the output that can be generated from MediDraw.

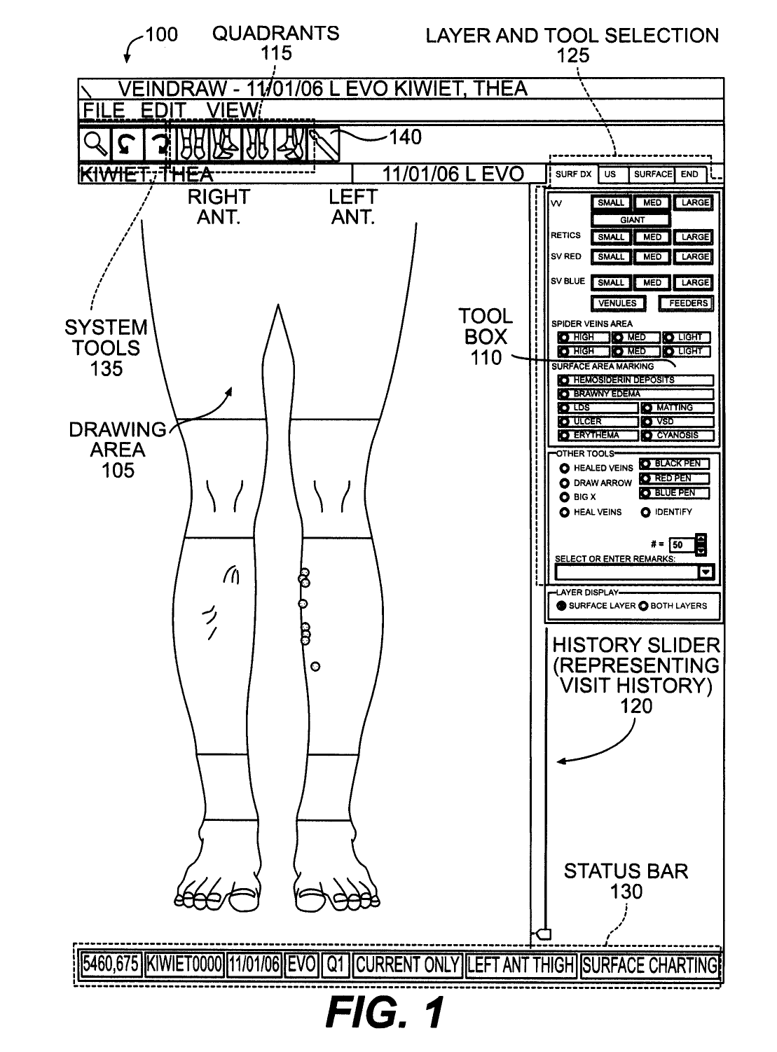

FIG. 1 is an illustration of an embodiment showing a user interface including a basic drawing area and related toolbox, constructed according to principles of the invention, generally denoted by reference numeral 100. The user interface 100 includes a drawing area 105 to permit input of a user, typically in freehand, and to view patient history, a toolbox area 110 for selecting various available tools and a quadrant option 115 for selecting various angles to view patient graphics. Also included in user interface 100 are a history slider 120 to view patient encounter history, a layer and tool selection option that may include multiple tabs for selecting different layers depending on the specialty, and a status bar 130 to display statuses of different system components. These different components of the user interface 100 are described in more detail below.

Quadrant option 115 permits different angles that a user may look at patient graphics. In the case of vein practice, there are typically four different “ways” (e.g., angles) called quadrants to view a subject. Each quadrant may have a different background layer. There's a zoom mode to show the four quadrants side by side so that a technician can get a bird's eye view of the patient. The history slider 120 provides a quick way to view patient encounter history. For example, each tick on the slider 120 indicates a patient encounter or visit. When the patient is coming for the first visit, there is only one encounter, as the patient comes for multiple visits and encounters, the number of ticks on the bar increases.

Layer and tool selection 125 may have different tabs to match the number of layers, depending on specialty area. In case of vein practice, there are typically two different layers: Surface (Diagnosis and treatment) and an Ultrasound layer. By selecting a particular layer, a certain number of tools become available. That is, the tool box 110 may change options, which vary depending on the layer selected but there are common tools that behave the same way regardless of the layer selected. Status bar 130 displays the status of different system components such as screen coordinates, current tool, quadrant, encounter date and type, patient chart, and the like. System tools 135 provide functions such as zoom, redo and undo, described more below.

### Layer System Description

Because the patient documentation is typically stored in a single file, the manner in which the data is displayed on the screen may be important. There are basically three ways to look at the layered system:

i. Background layer
The background layer is simply a drawing in either bitmap or vector format that represents the fixed information such as a vein map of the body, muscle layout or any drawing that represents the patient system. These drawings are presented lightly because the more the drawing in the background, the busier the picture is going to be.

ii. Anatomical layers within an encounter
In general, during an exam, the physician or technician examines the patient in many layers ranging from the skin exam to the systems and subsystems of the body. To represent such system graphically, different graphical layers are maintained to represent the exam. Some examples of these layers include: surface, ultrasound and x-ray. The display and maintenance of these layers vary by specialty. In vein care, the surface and ultrasound layers may be examined.

iii. Encounter (or visit) layers
During documenting a patient encounter, the technician is usually focused on the current encounter; however, it's also important to be able to see data from previous encounters so the technician can monitor the progress from one encounter to another. There are some implied and manual filters to allow data from previous encounters to be displayed. Observations from previous encounters are also important because of morphing tools that can change the status of data from a previous visit.

### Drawing Tools

The tool box 110 provides a set of marking tools that the technician can use to document a diagnosis or treatment. These tools are divided into groups for better organization. Each tool falls in one of the following categories:

i. Single Location tools
These tools are used by simply moving the cursor on the drawing area and clicking the mouse once and releasing it. As a result, a dot or a circle may be drawn of a specific color. Several of these markings can be drawn in succession (repeated) without releasing the mouse but they are not connected with lines.

ii. Branch tools
These tools are used by clicking down on the mouse, moving the cursor while the mouse is still clicked and then released. The initial point and last point are not the same. These are usually pictorially represented by a series of dots connected with lines. The lines are of different colors and thickness depending on the tool itself.

iii. Closed area tools
These tools are used by clicking down on the mouse, moving the cursor while the mouse is still clicked and then released. When the mouse is released, the last point may be connected to the first point. These are usually pictorially represented by a series of dots connected with lines. The lines are of different colors and thickness depending on the tool itself and the area inside may be filled with a pattern to show that this is an enclosed space.

iv. Selection tools
The selection tools are used to mark a previously drawn object so it is selected for further action.

v. Morphing tools
Morphing tools act upon an existing part of the drawing by making a new copy of the drawing segment then changing it.

vi. System tools
System tools perform necessary system functions such as zoom, undo, redo, etc.

### Exemplary Drawing Tools for Vein Practice

These tools may be used during the diagnosis phase of the exam. They may be used to (virtually) draw markings on the patient's top most skin layer. When one of these tools is selected, only the top layer may be drawn. Markings made on an historical visit, are still shown in the current encounter.

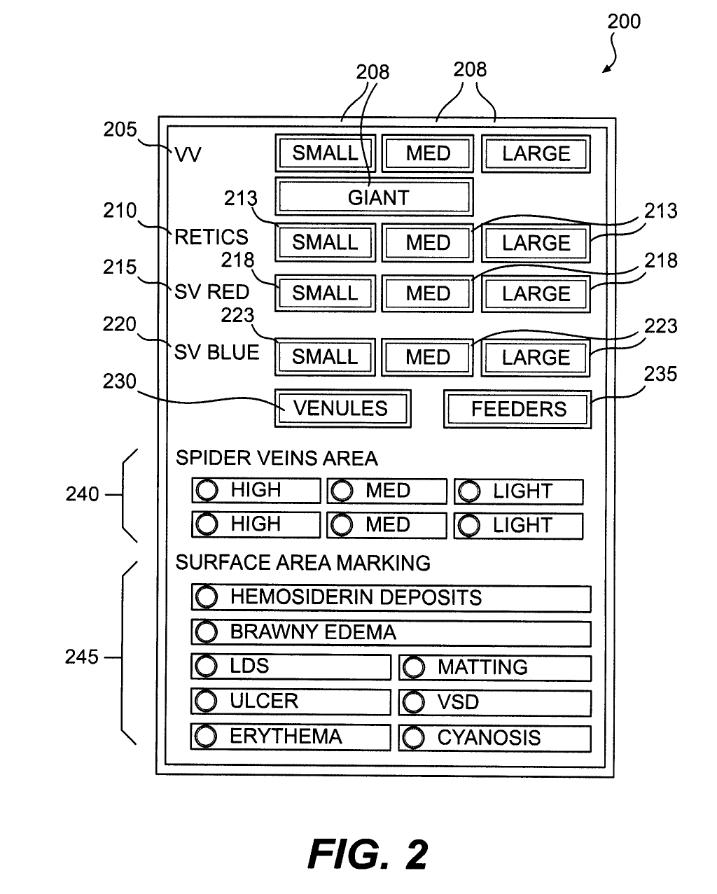

FIG. 2 is an illustration of an embodiment of the diagnosis tools, as part of the tool box 110, constructed according to principles of the invention, generally denoted as reference numeral 200. The tool selection options may be displayed in different thicknesses and colors for easy visual recognition by the user, and selectable for drawing types and variations of veins. As shown in the embodiment of FIG. 2, the tool options may include:
1. Varicose Veins 205 (Small, Medium, Large, Giant, designated generally by reference numeral 208) for drawing different sizes of varicose veins.
2. Retics 210 (Small, Medium, Large, designated generally by reference numeral 213) for drawing different sizes.
3. Spider Veins Red 215 (Small, Medium, Large, designated generally by reference numeral 218).
4. Spider Veins Blue 220 (Small, Medium, Large, designated generally by reference numeral 223).
5. Venules 230.
6. Feeders 235.

The following are tool options that may be presented in different color and hashing densities for easier visual recognition.

1. Blue Spider Veins Area 240 (High, Med, Light), and

2. Red Spider Veins Area 245 (High, Med, Light).

The following are single location tools (with possible repeats) typically drawn in different colors for easy visual recognition, generally designated collectively by reference numeral 245:

1. Hemosidern Deposits.

2. Brawny Edema.

3. LDS.

4. Ulcer.

5. Erythma.

6. Matting.

7. VSD.

8. Cyanosis.

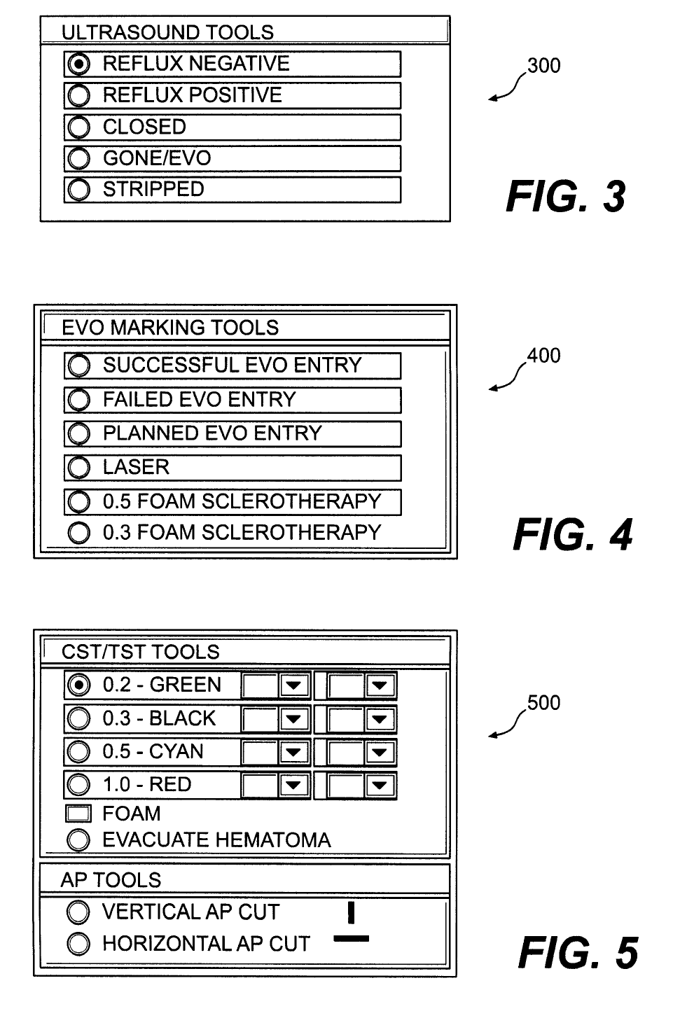

FIG. 3 is an illustration of an embodiment of ultrasound tools selection options, selectable for use by a user, constructed according to principles of the invention, generally designated by reference numeral 300. These tools are typically used during the diagnosis phase of an examination. They are used to (virtually) mark the vein system during the ultrasound portion of the examination. When one of these tools is selected, only the ultrasound layer may be drawn. Markings made on an historical visit, are still shown in the current encounter. All the ultrasound tools are branch tools. Each tool may be presented with a distinguishing color or font for easier visual identification and may include tools:

1. Reflux Positive.

2. Reflux Negative.

3. Closed.

4. Gone/EVO.

5. Stripped.

FIG. 4 is an illustration of an embodiment of Encovenous Obliteration (EVO) marking tools selection options, selectable for use by a user, constructed according to principles of the invention, generally designated by reference numeral 400. These tools are typically used during the treatment phase of the encounter. They are used to (virtually) mark the vein system during an EVO procedure. Generally, an EVO is a minimally invasive procedure for treating vein disease performed by inserting a catheter into the vein and turning a laser beam on to close the vein from the inside. The body then takes care of dissolving the vein without the need for surgery. When one of these tools is selected, only the ultrasound layer may be drawn. Markings made on an historical visit, are still shown in the current encounter. The EVO Entry tools are single point tools, and the laser as well as the Sclerotherapy is branch tools. The EVO marking tools include:

1. Successful EVO Entry,

2. Failed EVO Entry,

3. Planned EVO Entry,

4. Laser,

5. 0.5 Foam Sclerotherapy, and

6. 0.3 Foam Sclerotherapy.

FIG. 5 is an illustration of an embodiment of treatment tools selection options, selectable for use by a user, constructed according to principles of the invention, generally designated by reference numeral 500. These tools may be used during the treatment phase of the patient encounter. They may be divided into the two main procedures (in addition to the EVO), Sclerotherapy and Ambulatory Phlebectomy. When one of these tools is selected, only the surface layer may be drawn. Markings made on a historical visit, are usually not shown in the current encounter. The CST/TST tools may be single point tools (with repeat) and Evacuate Hematoma and AP tools are single tools without repeats. Pull down lists next to the different CST tools may be batch numbers which are used for documentation only.

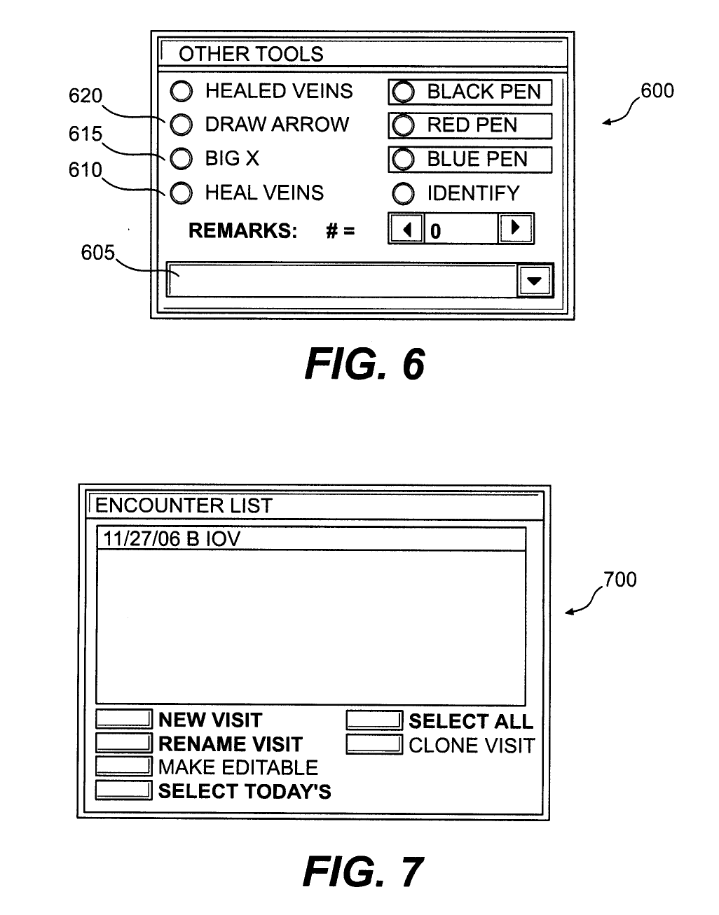

FIG. 6 is an illustration of an embodiment of other tool options, selectable for use by a user, constructed according to principles of the invention, generally designated by reference numeral 600. Generally, FIG. 6 includes text and annotation tools for inserting text or adding annotation, such as adding “healed veins,” to insert a big “X” 615 into the drawing, or to draw arrows 620, for example. “Healed veins” tool permits indicating that a vein has healed. Also, “remarks” tool 605 is not a graphical tool. Rather, it allows the user to insert text in either the surface layer or the deep layer for the purpose of further clarification of the drawing. The text keeps moving with the mouse until the user double clicks to leave the text in the “current” spot. When a # sign is used, it may be replaced with the number about the text in the tools box. Arrows can use used to connect the text with the actual area where the annotation applies. Applied colors may be selectable such as black and red pens.

“Heal Veins” 610 is a unique tool because it works on existing marks (e.g., from a previous treatment that indicated veins with trauma, or other characteristics). By moving the tool over existing surface vein marks, these veins are copied (cloned) in the current encounter and their characteristics are changed to reflect the “healing process,” from 0 to 100%. Moreover, tools are available that show improvements in different stages such as:
Improving,
Healing, and
Gone.

Referring again to FIG. 1, system tools 135 help make the documentation process easier by allowing the user to correct an error (e.g., counter-clockwise arrow) or restore or put the change back (e.g., clockwise arrow). The Zoom function (magnifying glass icon) may allow the user to have a high level view of multiple views at the same time. In case of Vein Care, the zoom function may permit the clinician to look at all the quadrants in one screen to determine the best plan for the patient.

FIG. 7 is an illustration of an encounter list, according to principles of the invention, generally denoted by reference numeral 700. The encounter list (or visit list) 700 may typically be a sorted list of the patient visits to the office, sorted by date. The encounter list 700 may include the following data:
1. Date: (of when the patient comes to the office)
2. Encounter type: e.g., reason for visit which may be specialty specific. In the case of vein care, it might include, for example:
   a. Initial Office Visit,
   b. EVO treatment,
   c. CST/TST Treatment,
   d. Follow up visits.
3. Encounter specific data such as the side of treatment (Left, Right, or both).

Moreover, the encounters have default behavior, which may be altered, such as:
By default, only today's encounter may be editable or can be modified.
Both diagnosis and treatment markers from today's encounter are shown.
Only diagnosis data from previous encounters are displayed.
When an encounter is selected (or highlighted), treatment markers are displayed.
When a single encounter is selected, additional functions such as rename or clone can be done.

From the encounter list 700, the user may perform the following functions:
Add Visit—adds an encounter, which permits the user to enter date and type of encounter.
Clone Visit—duplicates the data from a selected prior encounter to a new encounter. This may be useful when the condition for one visit is similar to a historical encounter.
Rename Visit—allows the user to correct data about a previous encounter including date of visit, type, etc.
Make Editable—because historical data is protected by default, “make editable” option permits the selection of a previous visit to change it.
Select Today's—if the user switched the current editable visit to another visit, “Select Today's” allows the user to return to today's visit quickly to continue documenting today's encounter.
Select all—allows the user to select all encounters to display the data from all encounters.

In addition, file maintenance tools (not shown) may be provided that might include tool options to:

Open Patient—the open patient command displays the file open dialog to load an existing patient file. An existing patient file would contain all the previous patient encounters' data.

Reload Patient—reload patient option allows the user to cancel any changes made to the file and restore the file as it was at the time of the last save.

Save Patient—save patient saves the current patient file with all the changed data. After the save, all the changes are put on the disk and become permanent.

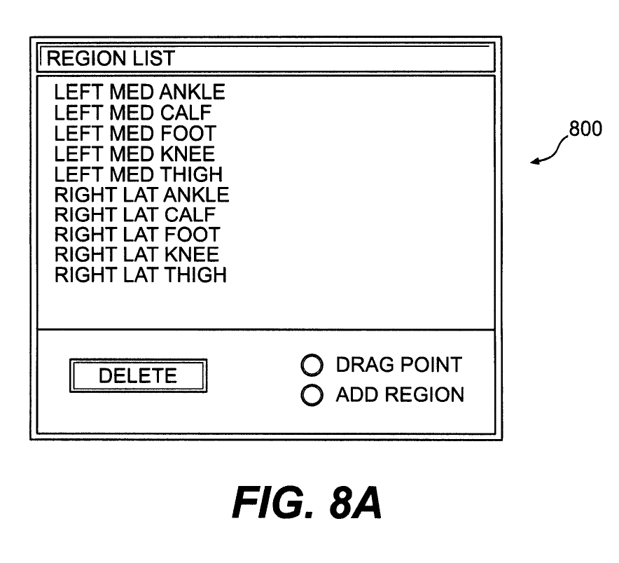

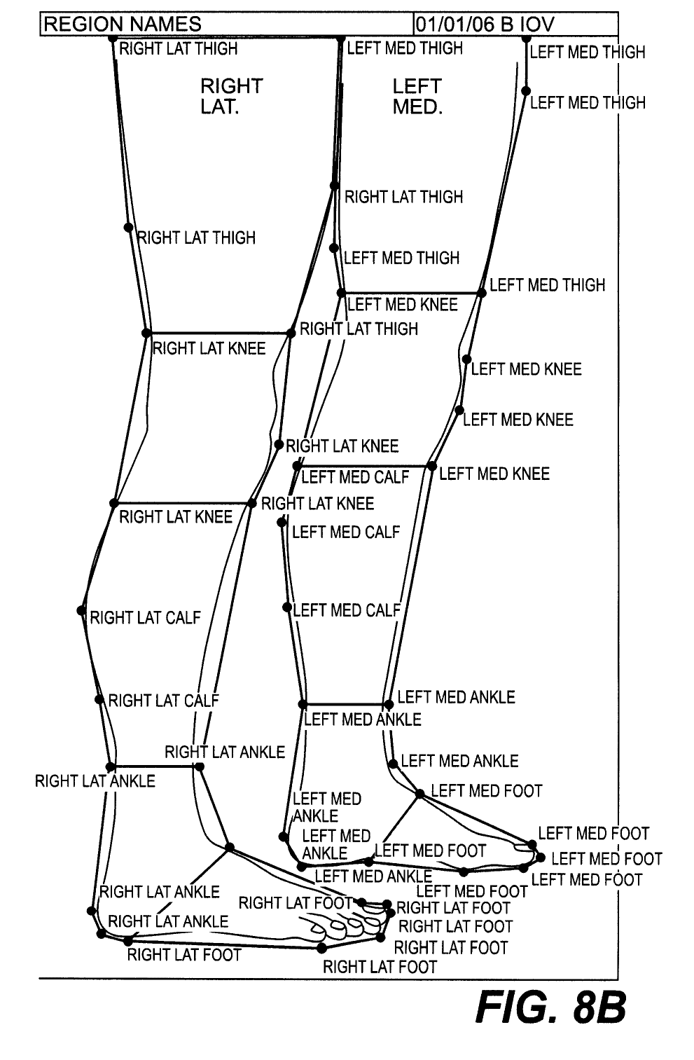

FIGS. 8A and 8B are illustrations of an embodiment showing region definition/editing tools, constructed according to principles of the inventions, generally denoted by reference numeral 800. By editing a patient chart called “TEST,” the program enters into a special mode for editing the regions. Regions (ten exemplary regions are listed in FIG. 8A) are areas in the patient drawing that are used to give names to the coordinates. Each Cartesian coordinate maps into a single region in the each quadrant which means that regions should not overlap. The name of the region may be used in the analysis of the sketch and converting it into text. When the user selects a regions editing mode, a special display for the regions appears which allows the user to add, delete, or modify a region.

When a region name is selected from the list, the region may be highlighted and shaded; the user may then push the delete button, for example, on the region list menu which deletes the whole region. The user may also select “Drag Point” which allows the user to pick a corner of the region and move it by holding the point using the mouse and dragging it to a new spot. By entering the name of a new region, the user can select Add Region to create a new region with the name entered in text field. FIG. 8B is an illustration of the anatomical regions corresponding to the list of FIG. 8A.

MediDraw includes a drawing component and an analysis component. All the graphical information is typically stored internally in a collection of tables that are usually saved in a single file per patient, although other techniques may be employed as known by skilled artisans. The graphical information may also be stored instead in database tables. Storage on a permanent media may also be possible, as long as the stored information may be loadable again into memory. In this implementation, the data may be partially saved in a database, such as the patient list and the visit list, while the coordinates may be stored in a file (typically one per patient).

In a preferred embodiment, Cartesian coordinates of the points in the drawing are typically made up of a series of 10 tables. Each added point may be a row in all the tables simultaneously. The variable pLMax indicates the maximum number of Cartesian points that can be used in the program and may be sized to be a large enough number so that a reasonably complete chart can be drawn, which may be complex. Each one of the following exemplary entries as shown in Table 1 carries a specific part of the information about the Cartesian coordinate, such as visit number, quadrant #, tool option and so forth, as shown. Single is equivalent to an integer, which is typically more efficient in processing.

TABLE 1

| | | |
|---|---|---|
| plV(pLMax) | Single | Visit Number |
| plQ(pLMax) | Single | Quadrant number |
| plX(pLMax) | Single | X Coordinates |
| plY(pLMax) | Single | Y Coordinates |
| plT(pLMax) | Single | Tool number |
| plO(pLMax) | Single: | Tool Option |
| plF(pLMax) | Boolean | Foam? |
| plM(pLMax) | Boolean | Mouse Down |
| plU(pLMax) | Boolean | Mouse Release |
| plE(pLMax) | String | Text or region name |
| plS(pLMax) | Boolean | Selected node |

In Table 1, the “Visit Number” indicates the number on the timeline on which this part of the drawing may be added. This value may be significant because it ties the coordinate to a date, and visit type. The “(x,y) coordinates” should be self explanatory to one of ordinary skill, as they indicate the location on the drawing “canvas.” The “Quadrant number” is the third coordinate needed to properly draw the point. It can be thought of as a discrete third dimension for each dot on the display. In this implementation, the Ultrasound versus the surface layer is implied, based on the tool used. In other specialties, it may be necessary to capture and store another coordinate for the depth of the point used.

Still referring to Table 1, “Tool number” and “Tool Option” is a pair of values that define the tool that drew this point on the canvas. For example, the tool could be either spider veins while the option indicates the thickness of the spider veins. During the drawing process, these values affect the color, width and characteristics of the graphical drawing. “Foam” is an option specific to Sclerotherapy and not relevant to other specialties.

“Mouse Down” and “Mouse Release” of Table 1 are binary or Boolean variables that mark the place when a mouse is clicked down or released. These are typically significant in the process of defining Single Coordinate, Branch, and Region tools. For example, if a mouse clicked down then released, a single point may be added, such as an EVO entry. On the other hand, if a mouse is clicked, while the mouse is down, the mouse is moved then released later, a series of coordinates are created with the first one having a mouse down event and the last one having a mouse release event. If the last point and first point are the same, it becomes a region instead. The tool and option are significant in determining the original intent of the user. “Text” may be used to store either surface or Ultrasound comments. The same field may also be used to store region names. In alternate embodiments, text may be associated with any other tool, and not just text tools.

The Patient list is currently stored in a Lytec database (from Lytec Systems, Inc., however other similar databases may be employed). There are at least three fields that are typically defined and used:

i. Chart Number: A unique number used to identify the patient.

ii. First Name: First name of the patient.

iii. Last Name: Last name of the patient.

When the MediDraw program is initiated, the chart number may be passed on as a command line parameter. The MediDraw program performs a database query to find the patient name in order to display it on the user display screen. In this way, patient information may be synchronized with any billing software being used by an enterprise (e.g., doctor's office) without duplicating the information between the two applications.

An “Encounter list” may also be stored, typically in the Lytec database (or similar database). Each time an appointment is created for the patient, the date, time, provider, and reason for the visit may be stored. The program reads the appointment table to obtain the existing past and future appointments for the patient and to populate a timeline so that current encounter may be documented, or the user might alternatively switch to a previous (historical) visit to document.

As shown in Table 2, the “Region list” (e.g., FIG. 8A) may be arranged in a way similar to the “coordinates list” of Table 1. When the user edits the “TEST” chart, the region tools may be shown to the user. These are stored in a file typically called “Regions.MVC,” for example. prMax may be a constant indicating the maximum number of points in all of the regions in all the quadrants and is set to a practical large enough number.

TABLE 2

| Tool name | Type | Purpose |
|---|---|---|
| prX(prMax) | Single | X Coordinate for point |
| prY(prMax) | Single | Y Coordinate for point |
| prM(prMax) | Boolean | Mouse click, indicates start of region |
| prU(prMax) | Boolean | Mouse Up, end of region |
| prQ(prMax) | Single | Quadrant for region |
| prE(prMax) | String | Text or name of region |

Tool behavior may be driven by tables that control all events from cloning a visit, displaying data in a specific layer, to the data analysis. Some of the data in these tables may be hard coded in the program; others may be saved in relational tables. Table 3 shows the Tool Names and related information, described more below.

TABLE 3

| Tool # | Opt # | Tool Name | Group |
|---|---|---|---|
| 0 | 0 | Reflux Negative | Reflux Negative |
| 0 | 1 | Reflux Positive | Reflux Positive |
| 0 | 2 | Closed Vein | Closed Vein |
| 0 | 3 | Gone/EVO | Gone or Treated by EVO |
| 0 | 4 | Stripped Vein | Stripped Vein |
| 1 | 0 | Giant Varicose Veins | VV Size > 6 mm |
| 1 | 1 | Large Varicose Veins | VV Size > 6 mm |
| 1 | 2 | Med Varicose Veins | VV Size = 2 to 6 mm |
| 1 | 3 | Small Varicose Veins | VV Size = 2 to 6 mm |
| 1 | 4 | Large Retics | Retics |
| 1 | 5 | Medium Retics | Retics |
| 1 | 6 | Small Retics | Retics |
| 1 | 7 | Feeders | Feeders |
| 1 | 8 | Venules | Venules |
| 1 | 9 | Large Blue Spider Veins | SV Size < 2 mm |
| 1 | 10 | Medium Blue Spider Veins | SV Size < 2 mm |
| 1 | 11 | Small Blue Spider Veins | SV Size < 2 mm |
| 1 | 12 | Large Red Spider Veins | SV Size < 2 mm |
| 1 | 13 | Med Red Spider Veins | SV Size < 2 mm |
| 1 | 14 | Small Red Spider Veins | SV Size < 2 mm |
| 2 | 0 | 0.2 Green TST/CST Injections | ST Injections |
| 2 | 1 | 0.3 Black TST/CST Injections | ST Injections |
| 2 | 2 | 0.5 Cyan TST/CST Injections | ST Injections |
| 2 | 3 | 1.0 Red TST/CST Injections | ST Injections |
| 3 | 0 | Successful EVO Entry | Successful EVO Entry |
| 3 | 1 | Failed EVO Entry | Failed EVO Entry |
| 3 | 2 | Planned EVO Entry | Planned EVO Entry |
| 3 | 3 | Laser Treatment | EVO Laser Treatment |
| 3 | 4 | 0.5 Foam Sclerotherapy | EVO 0.5 Foam Sclerotherapy |
| 3 | 5 | 0.3 Foam Sclerotherapy | EVO 0.3 Foam Sclerotherapy |
| 4 | 0 | Evacuate Hematoma | Evacuate Hematoma |
| 5 | 0 | Surface Comments | |
| 6 | 0 | Healed Veins | Healed Veins |
| 7 | 0 | Hemosedrin Deposits | Hemosedrin Deposits |
| 7 | 1 | Matting | Matting |
| 7 | 3 | Cyanosis | Cyanosis |
| 7 | 4 | Brawny Edema | Brawny Edema |
| 7 | 5 | Ulcer | Ulcer |
| 7 | 6 | VSD | VSD |
| 7 | 7 | Erythema | Erythema |
| 7 | 8 | LDS | LDS |
| 8 | 0 | Arrow | |
| 9 | 0 | Ultrasound Comments | |
| 10 | 0 | Vertical AP | AP incision |
| 10 | 1 | Horizontal AP | AP incision |
| 11 | 0 | High Density Blue Spider Vein Region | SV Size < 2 mm in Clusters |
| 11 | 1 | Medium Density Blue Spider Vein Region | SV Size < 2 mm in Clusters |
| 11 | 2 | Low Density Blue Spider Vein Region | SV Size < 2 mm in Clusters |
| 11 | 3 | Low Density Red Spider Vein Region | SV Size < 2 mm in Clusters |
| 11 | 4 | High Density Red Spider Vein Region | SV Size < 2 mm in Clusters |
| 11 | 5 | Medium Density Red Spider Vein Region | SV Size < 2 mm in Clusters |
| 12 | 0 | Pen Tool | |
| 13 | 0 | Big X | |
| 14 | 0 | Heal Veins | Veins healed through our treatment |
| 15 | 0 | Identify | |
| 16 | 0 | Regions Draw | |
| 17 | 0 | Regions Drag | |

Table 3 may be stored in MS Access table, for example. Each row indicates a tool number and options number. For each pair, there may be a “Tool name” and “Group.” These tools are specific to vein care, but may be expanded to work with many tools and tool options. The tool name is self explanatory but the tool group is typically used during the analysis phase to report on the region names that contain markers for each tool. If a “Group” name is blank, then this tool may not be included in the analysis process of the text.

Table 4 presents various tool options for various tool names, selectable for use, and as described more below.

TABLE 4

| Tool Name | Clone? | Tool Layer | Which Tab | Show When |
|---|---|---|---|---|
| toolUS | True | layerDeep | tabDeep | showAlways |
| toolSurface | True | layerSurface | tabSuperf | showAlways |
| toolCST | True | layerDeep | tabTreat | showSelected |
| toolEVO | True | layerSurface | tabDeep | showAlways |
| toolEvac | True | layerSurface | tabTreat | showSelected |
| toolText | False | layerBoth | tabSuperf | showSelected |
| toolHealed | True | layerDeep | tabCommon | showAlways |
| toolSArea | True | layerDeep | tabSuperf | showAlways |
| toolArrow | True | layerBoth | tabCommon | showSelected |
| toolDeepText | True | layerDeep | tabDeep | showSelected |
| toolAP | True | layerSurface | tabTreat | showSelected |
| toolSV | True | layerSurface | tabSuperf | showAlways |
| toolPen | False | layerBoth | tabCommon | showSelected |
| toolBigX | False | layerBoth | tabCommon | showSelected |
| tootHeal | False | layerBoth | tabCommon | showAlways |
| toolIdentify | False | layerBoth | tabCommon | showAlways |
| toolRegions | False | layerBoth | tabCommon | showAlways |
| toolDrag | False | layerBoth | tabCommon | showAlways |

1. Clone?: Indicates weather a point in the visit may be duplicated, if the visit is cloned.
Yes: Clone
No: Do not clone

2. Tool Layer: Which layer is the tool in:
layerDeep: This tool is displayed in the deep layer
layerSurface: This tool is displayed in the surface layer
layerBoth: This tool is displayed in the surface layer

3. Which Tab?: The tools tab which includes the tool:
tabDeep: This tool is displayed if the deep tab is selected
tabSuperf: This tool is displayed if the superficial tab is selected
tabTreat: This tool is displayed if the treatment tab is selected
tabCommon: This tool is displayed if the common tab is selected

4. Show When?
ShowAlways: This tool is displayed in all encounters
ShowSelected: This tool is displayed only when this encounter is selected.

When a certain tool is selected, the event typically sets two global variables:

pcT: Tool number selected.

pcO: Tool Option selected.

Exemplary values for these variables are listed in Table 4. As the mouse events happen, the Tool and Option are used to display the marks on the screen and may be saved together with the Cartesian coordinates in the events table.

An “optionTool” routine performs several tasks, including:

1. Finish tasks for the last tool.

2. Set global variables for the new tool and option.

3. Display the proper layer for the tool (Surface vs. Deep).

4. Redraw the screen, if necessary.

5. Change the mouse icon to the new tool icon.

### Marking and Storing the Drawing

There are four main mouse events that control how the user draws on the canvas. Although the user may be using a tablet, events typically arrive into the MediDraw program as mouse events. Each event handler may be structured similarly using a “case statement” which evaluates the currently selected tool to mark the drawing by adding entries to the Cartesian tables. These event handlers do not make changes to the display directly because the same routine which may be used to display the markers on the screen, also redisplays the screen whenever a refresh may be necessary.

The mouse down events (e.g., Mouse Down: Picture1_MouseDown(x,y) Event) either adds a single marker into the Cartesian coordinates list or starts a series of markers for branch tools and area tools. As explained earlier, there's a single tool and an option already selected or implied by the user so when the mouse is dropped in the display area, depending on the current tool, a point may be added, or not. An exemplary logical flow structure of the routine is as follows:
1. If in zoom mode, do not add anything, just return since no editing is allowed in zoom mode.
2. Save x,y coordinates and display them in the status bar.
3. Save StartX and StartY for later processing by arrow tool, region and area tools.
4. Mark a mouse down event (used for undo and start of a branch)
5. Depending on the tool do the following tasks:
   a) For single point tools: add a mark in the Cartesian list.
   b) For branch tools: add a mark.
   c) For region tools: mark the loop list.
6. Save lastx and lasty which are used to draw a line from each point to the next in branch and area tools.

The mouse move events (e.g., Mouse Move: Picture1_MouseMove(x,y) Event) happen by continuing to move the mouse while the mouse button is held down or the stylus on the Tablet PC. As a result we continue to add markers into the Cartesian coordinates list. At this point, the tool and the option as already selected or as implied by the user depending on the current tool, permits processing to continue.

An exemplary structure of the routine is as follows:
1. If in zoom mode, do not add anything, just return since no editing is allowed in zoom mode.
2. Save textX and textY coordinates and display them in the status bar.
3. Depending on the current tool, do the following tasks:
   a. For single point tools: add a mark in the Cartesian list.
   b. For branch tools: add a mark.
   c. For region tools: Mark the loop list.
4. Save lastx and lasty which are used to draw a line from each point to the next in branch and area tools.

The Mouse up event (e.g., Picture1_MouseUp (x,y) Event) completes the process of marking either a branch tool or a region tool. It may be still structured very similar to the previous two events in that it depends on the current tool and option. An exemplary logical structure of the routine is as follows:
5. If in zoom mode, do not add anything, just return since no editing is allowed in zoom mode.
6. Save x,y coordinates and display them in the status bar.
7. Set mouseUnclick to mark the end of series of events.
8. Depending on the current tool, do the following tasks:
   d. For single point tools: add a mark in the Cartesian list.
   e. For branch tools: add a mark.
   f. Close the loop for Spider Vein areas.
9. Set lastx and lasty to (−1) to indicate lines are no longer being drawn for areas or branch tools.

Two tools make use of the double click event (e.g., Picture1_DblClick event):
1) The region draw tool: a double click connects the last drawn point to the first point to close the area.
2) The text tool: the text keeps moving with each click until it is placed permanently by a double click.
   Both cases are typically handled in the DblClick event.

The mark image routine takes no parameters because all the data may be used as global variables. As shown in Table 5, there is a collection of global variables that define the current state of the program that gets updated when the mark routine is called.

TABLE 5

| Global Variable | Table Name | Usage |
|---|---|---|
| pcV | plV(pLCount) | Visit Number |
| pcQ | plQ(pLCount) | Quadrant # |
| textX | plX(pLCount) | X Coord |
| textY | plY(pLCount) | Y Coord |
| pcT | plT(pLCount) | Tool Number |
| pcO | plO(pLCount) | Tool Option |
| pcF | plF(pLCount) | Foam? |
| mouseClick | plM(pLCount) | Mouse Down |
| mouseUnclick | plU(pLCount) | Mouse Release |
| txtComments | plE(pLCount) | Text or region name |

The mark image routine also performs the following functions:
Whenever another row is added to the table pLCount is increased by +1. If the Cartesian coordinate table is all filled up, an error is displayed and the user can not add any more points.
Call clearDisplay to put the added event to the screen.
Replace the inch mark (″) with the word “inch” and the pound sign (#) with the count field from the display in txtComments field before inserting in the plE table.

### Drawing and Printing the Encounters

To create efficient and accurate code, the same routines for drawing the image on the screen are used for the screen and the printer as well as zoomed and unzoomed mode. To achieve this, two global variables may be used:

Destination of the draw function: either picture1 for screen, or printer.

OptionMode: set to either ZoomIn or ZoomOut

Check US: Checked (for deep layer) or Unchecked (for Superficial layer)

These variables are continually checked in the next routines during the display process to change the destination or size the chart appropriately.

Clear display (e.g., clearDisplay) performs the initial function of the display image process. The destination (screen or printer) are initialized and the background (depending on the quadrant, layer, and zoom mode) is displayed on the canvas.

Since the zoomed display may be in landscape mode, as opposed to the regular portrait mode used in the unzoomed mode, the ZoomX and ZoomY functions perform the coordinate conversion between zoomed and unzoomed modes for orientation on a printer. Each function takes two parameters (X, Y) and returns either calculated X or Y. The drawMark routine which actually places the images on the screen or printer is unaware of the orientation on the screen or the printer; instead it takes the measurements from ZoomX and ZoomY.

The exemplary displayImage routine is typically called from many different places of the MediDraw program when it becomes necessary to redisplay the image, such as after loading a new chart or the user elects to send the chart to the printer. The displayImage routine functions the same regardless of the destination or the display modes. The above global variables may be checked to find out if a Cartesian coordinate should be displayed. Other factors affecting the display include:
Type of tool: some tools are displayed on all layers while others only displayed in their prospective layers.
Selected visit: when the user moves the history slider, the current visit may be changed, as a result all the tools of the current visit may be displayed (diagnostic, treatment, and text). The displayImage routine includes a large “For” loop going through all the Cartesian points from 0 to pLCount (current defined points) and if the point matches the current filter rules, the drawMark routine may be called to display the current point on the canvas or printer.

The exemplary drawMark routine works with global variables that describe the Cartesian point to be displayed on the screen on printer. The routine includes a large Case Statement that may be dependent on the current pcT (tool) and pcO (tool option). The location of the mark is at the x,y coordinate. The coordinates (x,y) have already been calculated based on the zoom mode and destination (screen vs. printer). Depending on pcT and pcO, a collection of lines, dots, and circles may be created. The colors are hard coded in some cases (e.g., using the Visual Basic constants such vbRed, vbMagenta, etc.) as well as the background and foreground colors of objects displayed on the screen. Using these objects on the screen makes the customization of the program easier.

As explained earlier, the printing process may be simplified considerably because the printing has been shared with the drawImage routine. The cmdPrint routine may perform one of more of the following steps:

1. Set destination to printer.

2. Set zoom mode on.

3. Open the common dialog to select a printer.

4. If the user cancelled the print, return.

5. Print the header on the printer.

6. call the drawImage routine to perform the print.

The exemplary loadImage routine may be used to load the patient chart information from the file (assuming that there is a file already for the patient). Due to potential different versions of the MediDraw program, different version numbers of the file exists. The version number may be stored as the first line of the file. Saving the version number of the file makes changing the program features easier. The patient files may be stored in a common patient folder named as: xxxxxxx.mvc where xxxxxxx is the patient's chart number.

The patient file is typically saved in ASCII code and typically includes three sections:

Section 1: Patient's Previous Encounter List

The appointment list starts with the version number, followed by a series of dates in mm/dd/yy format, the patient's side Left, Right, or Both, then the procedure code. The section ends with a line “END”.

Example:

V1.5
09/27/06 L EVO
10/04/06 R EVO
10/18/06 L EVO
END

Section 2: Batch Numbers for Sclerotherapy Shots

Batch numbers are a series of letter and number pairs. There are 4 pairs needed for each encounter for the 4 different concentrations of the Sclerotherapy product. This section also ends with a single line containing “END.”

Section 3: Cartesian Coordinates, Tools, and Other Options

Each line in this section includes a row of data for the following tables:

| | | |
|---|---|---|
| plV(pLMax) | Single | Visit Number |
| plQ(pLMax) | Single | Quadrant # |
| plX(pLMax) | Single | X Coord |
| plY(pLMax) | Single | Y Coord |
| plT(pLMax) | Single | Tool number |
| plO(pLMax) | Single: | Tool Option |
| plF(pLMax) | Boolean | Foam? |
| plM(pLMax) | Boolean | Mouse Down |
| plU(pLMax) | Boolean | Mouse Release |
| plE(pLMax) | String | Text or region name |
| plS(pLMax) | Boolean | Selected node |

End of file indicates the end of the list.

Example:

3075,2235,1,1,0,#TRUE#,#FALSE#,#FALSE#,0,“ ”,#FALSE#

3075,2250,1,1,0,#FALSE#,#FALSE#,#FALSE#,0,“ ”,#FALSE#

3030,2310,1,1,0,#FALSE#,#FALSE#,#FALSE#,0,“ ”,#FALSE#

3090,2370,1,1,0,#FALSE#,#FALSE#,#FALSE#,0,“ ”,#FALSE#

The patient's visit list (appointment table) may also be stored in the database as an appointment list typically including:
Chart: Chart number for patient, must match the current patient.
Date: Date of Patient's Appointment.
Side: This is specific to vein care (left, right, or both).
Procedure: Procedure type (IOV, EVO, AP, etc.).

While loading the appointment list from the database using a SQL statement, only certain encounters are significant to the veinDraw application and may be added to the list, other appointment types are usually ignored. This may be performed in the loadVisitList( ) procedure.

The patient's list of encounters stored in the file is usually redundant and it must be reconciled with the appointment table during the load process. This may be done by matching the dates and procedure code between the two tables. Alternatively, this file could be eliminated and all the data can be stored in the database.

Saving patient charts is typically a straightforward process which typically includes the following steps:
Rename the old file if it exists to xxxxxxxx.old where xxxxxxxx is the patient's chart number.
Open the file for output.
Write the following data:
   File version number, e.g., “V1.5”
   Patient's Encounter list ending with “END”
   Batch numbers for Sclerotherapy ending with “END”
   Write all the (x,y) Cartesian coordinates, tool number, tool options, mouseclick, mouseunclick events, as well as the text comments or region name.

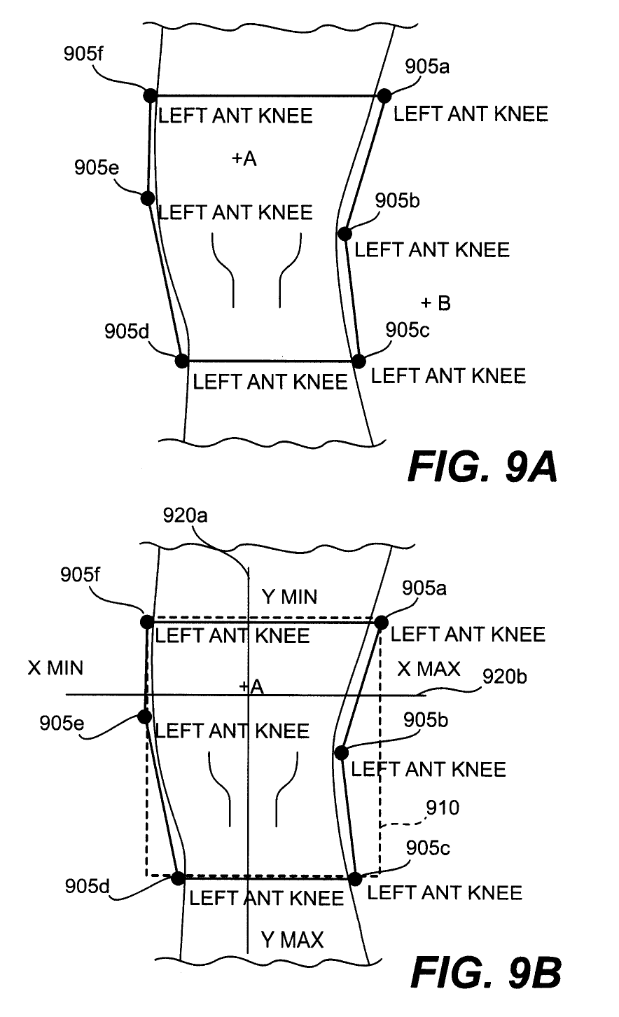

FIGS. 9A and 9B are illustrations of an embodiment showing pictorially a process of converting coordinates to region names as part of the text generation process, according to principles of the invention, generally denoted by reference numeral 900. However, the implementation specifics can be done in various ways as a skilled artisan would recognize.

Regions may be defined as closed convex polygons that may be created by editing a chart named “TEST” as explained earlier. An example is shown in FIGS. 9A and 9B for a region called: “Left Ant Knee,” as defined by coordinates 905a-f. The point “A” is inside the region “Left Ant Knee,” while point B is outside the defined region.

By way of example, function findRegionName(X, Y, Q) takes a pair of coordinates x and y as well as a quadrant (equivalent to a third degree of freedom) and returns the name of the region number in which the point (x,y) lies within. If the point (X,Y) does not fall within any region, the function returns a null value. If the point falls within multiple regions, the function returns the number of the first region it finds. Again, the assumption here is that the regions do not overlap within a certain quadrant Q.

Referring to FIG. 9B, The function findRegionName starts by finding a smallest rectangle 910 that can be drawn outside the region which is defined by the coordinates: (XMin, YMin), and (XMax, YMax). Then intersection points are found of extending the vertical 920a and horizontal lines 920b from the point A in all four directions. If the intersection between these lines and the rectangle defined by (XMin, YMin) and (XMax, YMax) are inside the box 910 then the point A is inside the region. Although this is an approximation, it is sufficient for determining regions. It may be worthy to note that complex concave polygons can be divided into multiple convex polygons with the same name. In alternate implementations of MediDraw, a library function from Microsoft's Visual Basic.Net tools may be used to calculate the region names.

### Text Generation or Chart Analysis

In addition to the visual representation of the documentation outlined above through the drawing part of the program, the text generation from the chart is a rather prominent aspect of MediDraw. As explained earlier, the chart is typically saved using a series of Cartesian coordinates together with tools and tool options associated with these Cartesian coordinates. Add to that the tool names table and the region names, and the analysis becomes quite straightforward.

The analysis process typically uses a separate form that includes a multi-line text field and an OK button to close the form. Upon pressing the Analysis button 140 (FIG. 1), the analysis window opens and begins the analysis process. The analysis may be performed including the following steps:
1. Clear analysis text on the form.
2. Find the names of all regions defined. The names of these regions are stored in a regNames table.
3. For Each of the visits in the file:
   a. Clear counts of tools in the chart
   b. Calculate the total number of occurrences of each group (a group may be a collection of tools and tool options as explained in the tool table):
      i. Every time an occurrence of a tool in a region is found, add 1 to the table entry groupNames(g1,r1) where g1 is the group number and r1 is the region name.
   c. A count of all the occurrences of a tool group within a visit is now known, together with the regions in which these occurrences happen.
4. Print or display results.

The system and related methods as described above also provides for excellent documentation, thereby enhancing patient care and charge capture at the same time. Furthermore, such a system and methods is typically time and cost efficient for most clinicians since drawing a picture of the physical findings may be all that is necessary to record an encounter, the intervention or the diagnostic imaging results; the rest of the “work” may be performed by the MediDraw related components and computer. Restating, the work needed to produce a typewritten text description (normally done with dictations or templates which are later processed by other personnel) and the work needed to produce the coding needed for billing (normally done with forms and checkboxes, then later processed by other personnel) may be supplanted by a simple drawing of the gross visual patient findings.

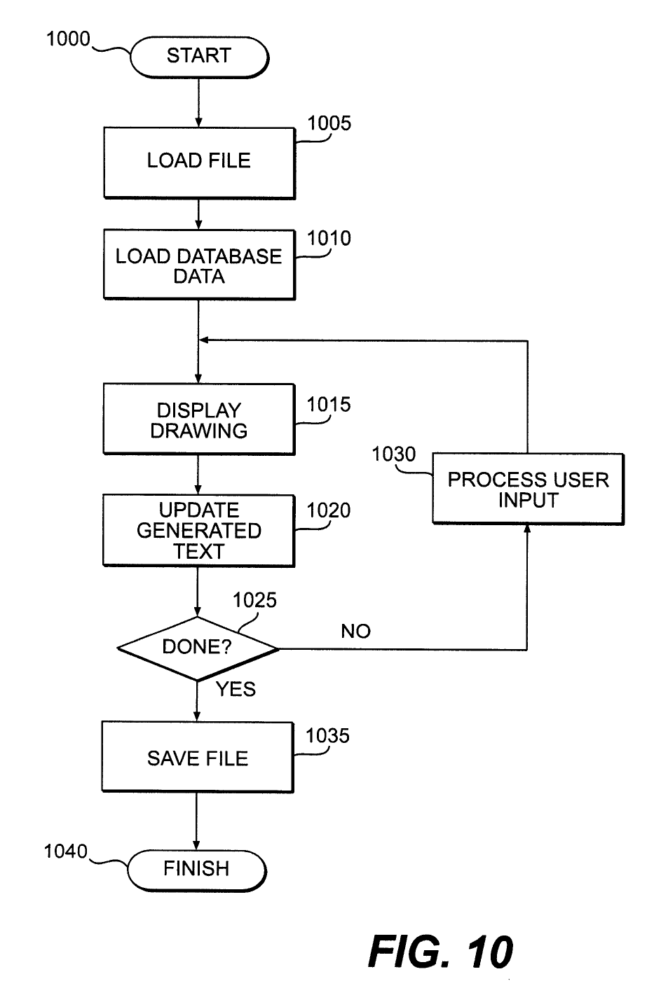

FIG. 10 is a flow diagram of an embodiment showing steps of using MediDraw, according to principles of the invention, starting at step 1000. FIG. 10 (and all other flow diagrams herein) may also represent a block diagram of the components for performing the steps thereof. All steps described herein may be implemented by a corresponding software component executing each respective step on an appropriate computer processing platform having suitable input and output interfaces for supporting the functional operation of the system and methods in accordance with the principles of the invention. Alternatively, the software components may be embedded as executable logic stored a computer readable medium such as memory, hard disk, CD-ROM, and the like, and when read and executed by the computer processing platform, performs the respective steps.

Continuing with step 1005, a file may be opened to load any Cartesian coordinates along with any tool values to begin a session. At step 1010, associated patient data may be loaded from a database, such as name and previous encounter data. At step 1015, the process loops through all the Cartesian coordinates and displays the appropriate dots and lines on a display device, with associated colors and context related to or reflective of the patient condition and any diagnosis. At step 1020, the Cartesian coordinates are processed with associated tools to generate text representing the drawing, reflecting one or more of patient condition, diagnosis, treatment, progress, and the like.

At step 1025, a check may be made whether or not the user is finished, such as by receiving a “save” and/or an “exit” request. If not finished, then the process continues at step 1030 to receive any user input which may include mouse clicks in different areas of the display, which may result in changing Cartesian coordinates, selecting or changing a tool, or change the display filters (e.g., to view other aspects or angles of a patient region, or to choose another region, etc.).

If however, the user has indicated that the session is finished, at step 1035, the current Cartesian coordinates may be written (i.e., saved) to a file. At step 1040 the process ends.

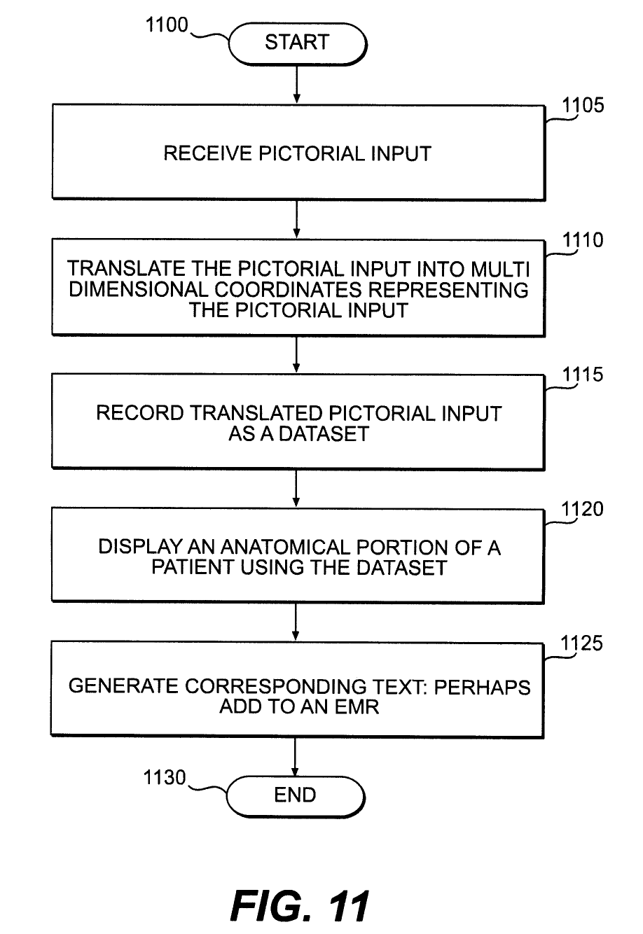

FIG. 11 is a flow diagram of an embodiment showing steps of the invention, starting at step 1100. At step 1105, receive pictorial input that represents at least one of a physical finding and a treatment associated with an anatomical portion of a patient. The region of the anatomical portion may be pre-presented to a user for the user to create the pictorial input. At step 1110, translate the pictorial input into Cartesian coordinates (or other multi-dimensional coordinate system) representative of the received pictorial input. The pictorial input may be hand drawn (free-hand) input. The translating may also translate the pictorial or free-hand input into Cartesian coordinates representative of the received free-hand input relative to the computer generated visual representation of a body part.

At step 1115, record the translated pictorial input as a dataset for storing. The dataset may record the multi-dimensional attributes, diagnosis attributes, treatment attributes, status attributes, and/or historical characteristics of the anatomical portion of a patient, reflective of the pictorial input, and may translate the information, or portions thereof, into corresponding text. The dataset may be recallable for annotation or updating. At step 1120, display the anatomical portion of the patient using the dataset to facilitate recording a progress note, diagnosis, a treatment, or the like, associated with the patient. At step 1125, the pictorial input, the annotated dataset, and/or pictorial output of an anatomical portion based on the dataset may be added to, or associated with, an EMR, and may include medical and/or billing codes. The dataset may include a numeric code that represents a medical condition of at least a part of the anatomical portion of a patient, represents a particular type of pathology, represents a resolution of a pathology, represents imaging results, and/or represents a procedure performed. At step 1130, the process ends.

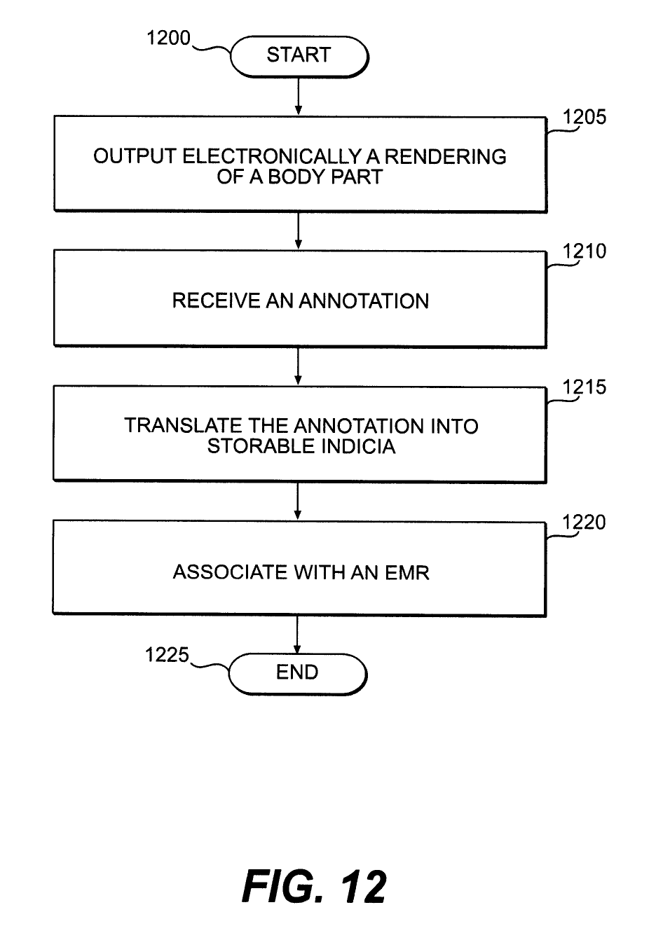

FIG. 12 is a flow diagram of an embodiment showing steps of using the invention, starting at step 1200. At step 1205, output an electronic rendering of a body part based on a selection for receiving a pictorial annotation representative of a medical condition or treatment of at least a portion of the body part. At step 1210, receive the pictorial annotation for processing. At step 1215, translate the pictorial annotation into storable indicia representative of the pictorial annotation so that the indicia are recallable for updating with additional annotation. At step 1220, associate at least one of the pictorial annotation and the storable indicia with an electronic medical record (EMR, viewable as part of the EMR. At step 1225, the process ends.

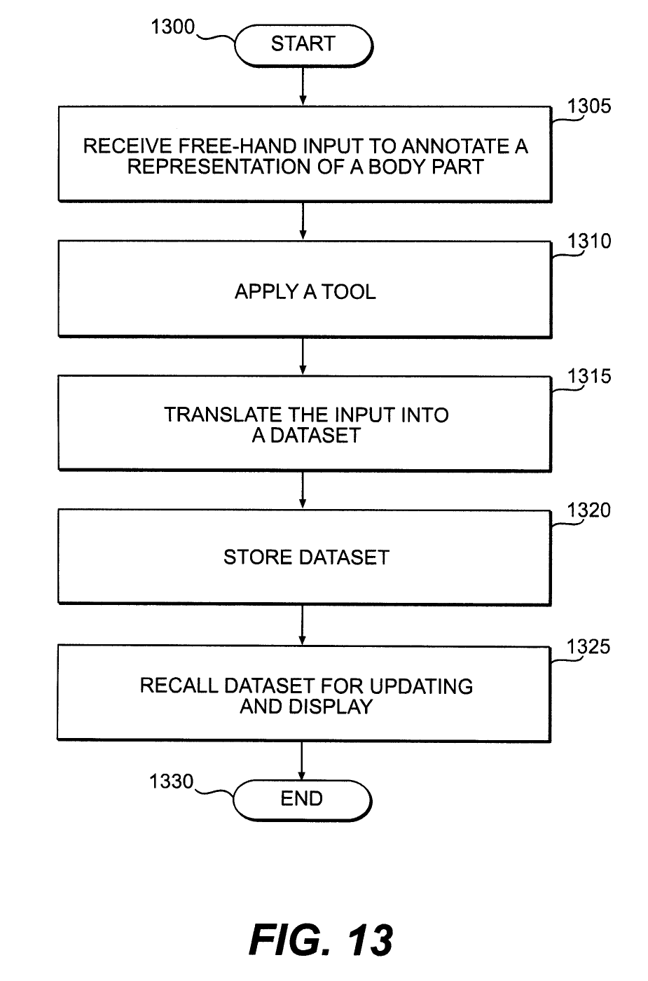

FIG. 13 is a flow diagram of an embodiment showing steps of using the invention, starting at step 1300. At step 1305, receive free-hand input to annotate a computer generated visual representation of a body part. At step 1310, a tool may be selected for applying attributes to annotate the body part such as size, condition, coloration, depth, progress information, or related medical information. The tool may apply a visual context to the annotated computer generated visual representation of a body part, as selected by a user, such as one or more of a color, a size, a depth, and the like. The tool may also provide, when selected by a user, specialized attribution based on the type of tool, such as ultrasound attributions or vein related attributions, for example. At step 1315, translate the free-hand input to a dataset representative of multiple characteristics of the body part. At step 1320, store the dataset to record characteristics and annotation of the body part, which may include multi-dimensional aspects, such as Cartesian coordinates for the image and/or annotations. The dataset may also store tool information for use in properly recreating the image with annotations and characteristics. At step 1325, recall the dataset for updating and display to track historical progress of the body part during treatment; alternatively, or in addition, associating the information contained in the dataset with an electronic medical record (EMR). The dataset or pictorial annotation may be included along with a generated current procedural terminology (CPT) code or international classification of diseases (ICD-9) code based on the dataset, as part of the electronic medial record (EMR). The generated CPT code and the generated ICD-9 code may be used for billing purposes. The dataset may also include coding that represents a medical condition of at least a portion of the body part, represents a particular type of pathology, represents a resolution of a pathology, represents imaging results, and/or represents a procedure performed. At step 1330, the process ends.

Various modifications and variations of the described methods and systems of the invention will be apparent to those skilled in the art without departing from the scope and spirit of the invention. For example, one or more steps of one embodiment may be performed in another embodiment. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A system for capturing medical information, comprising:
a first software component that receives pictorial input that represents at least one of a physical finding and a treatment associated with an anatomical portion of a patient;
a second software component that translates the pictorial input into Cartesian coordinates representative of the received pictorial input;
a third software component that records the translated pictorial input as a dataset for storing, wherein the dataset is recallable for annotation or updating; and
a display software component that is configured to output information related to the anatomical portion of the patient using the dataset to facilitate recording a diagnosis or a treatment associated with the patient,
wherein all of the software components execute on a computer platform having an input and output interface.

2. The system of claim 1, wherein the first software component receives textual information associated with the pictorial input.

3. The system of claim 1, wherein the received pictorial information is received as drawn free-hand user input.

4. The system of claim 1, further comprising a fourth software component that executes and outputs a graphical presentation of a body part prior to receiving the pictorial input to aid in capturing and associating the pictorial input with the body part.

5. The system of claim 4, wherein the graphical representation of the body part is preselectable by a user.

6. The system of claim 4, wherein the outputted graphical presentation is associated with a quadrant for receiving input associated with that quadrant.

7. The system of claim 1, further comprising a fifth software component that executes and generates a text description based on the received pictorial input.

8. The system of claim 7, wherein the generated text description comprises a part of an electronic medical record (EMR).

9. The system of claim 1, further comprising a sixth software component that executes and generates a current procedural terminology (CPT) code or international classification of diseases (ICD-9) code based on the received pictorial input as part of a electronic medial record (EMR).

10. The system of claim 9, wherein the generated CPT code and/or the generated ICD-9 code is used for billing purposes.

11. The system of claim 1, wherein the first software component is any one of: a spider vein marking tool, a varicose vein marking tool, a laser treatment tool and a sclerotherapy treatment tool.

12. The system of claim 1, wherein the dataset includes a code to indicate graphical characteristics of the received pictorial input including at least any one of: a color of a line, a width of a line, and transparency of a line.

13. The system of claim 1, wherein the dataset includes a numeric code that represents a medical condition of at least a portion of the body part, represents a particular type of pathology, represents a resolution of a pathology, represents imaging results, or represents a procedure performed.

14. The system of claim 1, wherein the dataset includes information indicative of a tool used to annotate the anatomical portion of the patient.

15. A method for capturing medical information, comprising:
outputting to a display an electronic rendering of a body part based on a selection for receiving in response a pictorial annotation representative of a medical condition or treatment of at least a portion of the body part;
receiving the pictorial annotation;
translating the pictorial annotation into storable indicia representative of the pictorial annotation so that the indicia are recallable for updating with additional annotation; and
associating at least one of the pictorial annotation and the storable indicia with a electronic medical record (EMR) viewable as part of the EMR.

16. The method of claim 15, further comprising the step of:
translating the pictorial annotation into text and including the text as part of the electronic medical record.

17. The method of claim 15, wherein the outputting is associated with a quadrant for capturing an annotation or displaying a particular view associated with an angle from among different angles for viewing the at least a portion of the body part.

18. The method of claim 15, wherein the pictorial annotation is representative of a medical condition of at least a portion of the body part, represents a particular type of pathology, represents a resolution of a pathology, represents imaging results, or represents a procedure performed.

19. A method of documenting medical findings, the method comprising:
receiving free-hand input to annotate a computer generated visual representation of a body part;
translating the free-hand input to a dataset representative of multiple characteristics of the body part; and
associating the information contained in the dataset with an electronic medical record (EMR).

20. The method of claim 19, further comprising processing a request to apply a tool for annotating the computer generated visual representation of the body part, the tool applying and storing as part of the dataset a visual context to the annotated computer generated visual representation of the body part

21. The method of claim 20, wherein the applying a visual context provides at least one of a color attribute and a size attribute indicative of a condition or status of at least a portion of the body part.

22. The method of claim 19, further comprising the step of generating a current procedural terminology (CPT) code or international classification of diseases (ICD-9) code based on the dataset as part of an electronic medical record (EMR).

23. The method of claim 22, wherein the generated CPT code and the generated ICD-9 code is used for billing purposes.

24. The method of claim 19, wherein the dataset includes coding that represents a medical condition of at least a portion of the body part, represents a particular type of pathology, represents a resolution of a pathology, represents imaging results, or represents a procedure performed.

25. The method of claim 19, further comprising storing as part of the dataset information related to a tool that annotates the computer generated visual representation of the body part

26. A method of documenting medical findings, the method comprising:
receiving a tool selection to select a tool for annotating a computer generated visual representation of a body part;
receiving free-hand input to annotate the computer generated visual representation of a body part;
translating the free-hand input to a dataset representative of multiple characteristics of the body part, the dataset including information related to the tool selected for annotating the computer generated visual representation of a body part; and
recalling the dataset and using the stored information related to the tool for recreating the annotated computer generated visual representation of the body for display or updating.

27. The method of claim 26, wherein the translating step translates the free-hand input into Cartesian coordinates representative of the received free-hand input relative to the computer generated visual representation of a body part.
